(19) United States
(12) Patent Application Publication
(10) Pub. No.: US 2023/0048348 A1
(43) Pub. Date: Feb. 16, 2023

(54) PUSH SCOOTER

(71) Applicant: Anita Wu, Dongguan City (CN)

(72) Inventor: Neil Owen, Dongguan City (CN)

(21) Appl. No.: 17/400,836

(22) Filed: Aug. 12, 2021

(51) Int. Cl. B62K 5/02; B62K 5/05

(52) U.S. Cl. CPC B62K 5/02; B62K 5/05

(57) ABSTRACT

A push scooter is provided, including: a deck, a wheel, a seat mechanism, a footrest and an adjusting assembly, wheels being disposed at a front end and a rear end of the deck, the footrest being disposed at the front end of the deck, the seat mechanism being adjustably disposed on the deck by the adjusting assembly.

### BACKGROUND OF THE INVENTION

### Field of the Invention

The present invention relates to a push scooter.

### Description of the Prior Art

Child carriages are provided for children's easy travel. The child carriage generally includes a frame, wheels, a seat mechanism, a grip handle and a push handle assembly. The frame of the conventional child carriage is constructed by a plurality of rods. The seat mechanism and the footrest are fixedly connected to specific ones of the rods, which results in extremely inconvenient and non-flexible adjustment of the seat mechanism, the footrest and other mechanisms relative to the frame, so it cannot adapt well to infants or children with different statures, and the compatibility and flexibility are worse.

The present invention is, therefore, arisen to obviate or at least mitigate the above-mentioned disadvantages.

### SUMMARY OF THE INVENTION

The main object of the present invention is to provide a push scooter which is easily adjustable in position of a seat mechanism, and provides good compatibility and flexibility.

To achieve the above and other objects, a push scooter is provided, including: a deck, a wheel, a seat mechanism, a footrest and an adjusting assembly, wheels being disposed at a front end and a rear end of the deck, the footrest being disposed at the front end of the deck, the seat mechanism being adjustably disposed on the deck by the adjusting assembly.

With the seat mechanism disposed on the adjusting assembly which is adjustably disposed on the deck, the seat mechanism is forwardly, backwardly, upwardly and downwardly adjustable relative to the deck so that it provides more flexibility in adjusting seating space for children with different statures.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing of a preferable embodiment of the present invention;

FIG. 2 is a stereogram of a preferable embodiment of the present invention; and

FIG. 3 is a cross-sectional view of a preferable embodiment of the present invention.

### DETAILED DESCRIPTION OF THE PREFERRED EMBODIMENTS

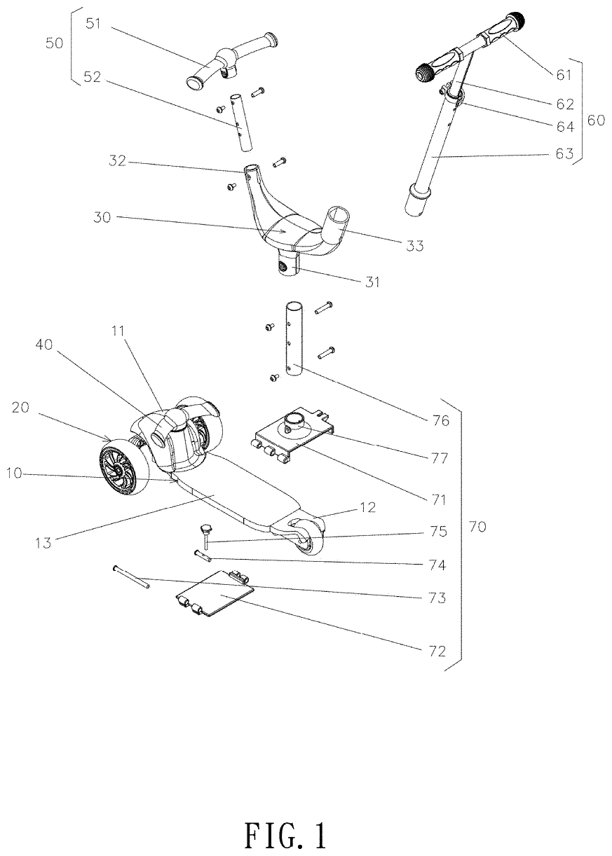

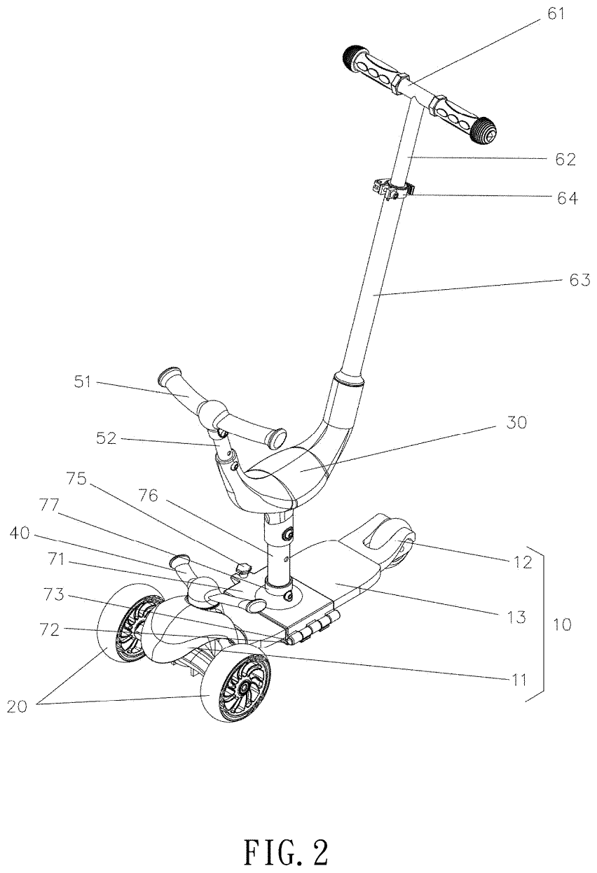

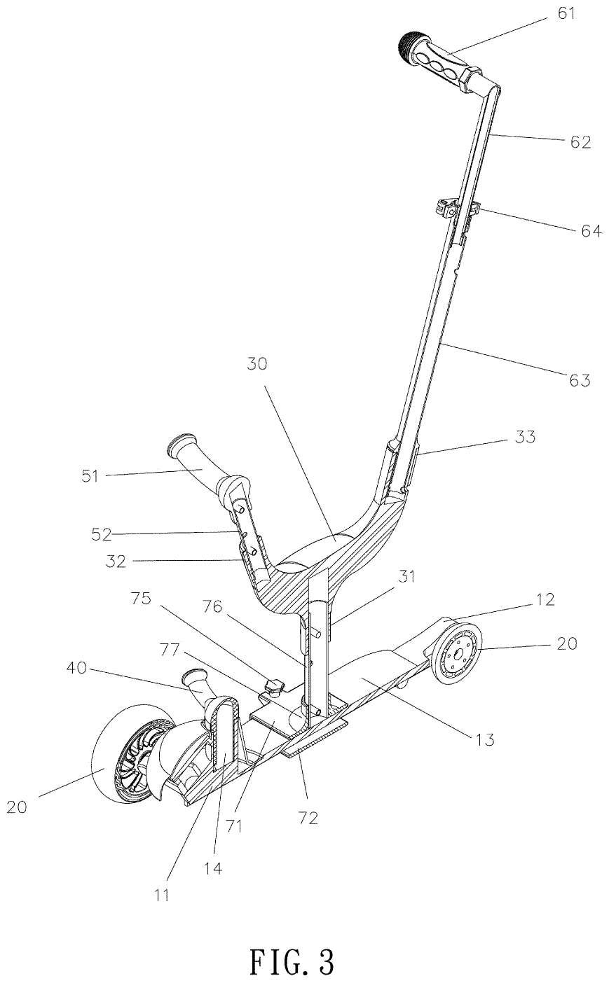

Please refer to FIGS. 1 to 3 for a preferable embodiment of the present invention. A push scooter of the present invention includes a deck 10, wheels 20, a seat mechanism 30, a footrest 40, a handle assembly 50, a push handle assembly 60 and an adjusting assembly 70. The wheels 20 are disposed respectively at a front end and a rear end of the deck 10. In this embodiment, the wheels 20 include two front wheels and a rear wheel. The footrest 40 is disposed at the front end of the deck 10. Preferably, the footrest 40 is detachably assembled to a mounting hole 14 of the deck 10, and the mounting hole 14 is configured for mounting of a steering bar (not shown). The seat mechanism 30 is adjustably disposed on the deck 10 by the adjusting assembly 70. The handle assembly 50 is adjustably connected to a front end of the seat mechanism 30. The handle assembly 50 is adjustable in length along a direction oblique to the deck 10 so that a height of the handle assembly 50 relative to the seat mechanism 30 and a relative position of the handle assembly 50 in front of the seat mechanism 30 are adjustable, for providing more compatibility and flexibility according to children with different statures, leg and/or arm extents. The push handle assembly 60 is adjustably connected to a rear portion of the seat mechanism 30.

The deck 10 includes a front portion 11, a rear portion 12 and a board 13 connected between the front portion 11 and the rear portion 12. The adjusting assembly 70 is connected to the board 13 and adjustably positioned in one of various locations between the front portion 11 and the rear portion 12. The seat mechanism 30 is disposed on the adjusting assembly 70.

Specifically, the adjusting assembly 70 includes an upper plate 71 and a lower plate 72. The board 13 is releasably clamped between the upper plate 71 and the lower plate 72 so that the adjusting assembly 70 is forwardly and backwardly adjustable with the seat mechanism 30 relative to the board 13 of the deck 10. The adjusting assembly 70 further includes a hinge shaft 73, a lock shaft 74 and a bolt 75. Sides of the upper plate 71 and the lower plate 72 at a side of the deck 10 are hinged by the hinge shaft 73, and sides of the upper plate 71 and the lower plate 72 at another side of the deck 10 are releasably locked by the lock shaft 74 and the bolt 75. In this embodiment, the upper plate 71 and the lower plate 72 each have at least one hinging hole through which the hinge shaft 73 is disposed, and at least one of the upper plate 71 and the lower plate 72 further has at least one locking hole through which the lock shaft 74 is disposed. When the upper plate 71 and the lower plate 72 fixedly clamp the board 13 and the lock shaft 74 is inserted in the at least one locking hole, the upper plate 71 and the lower plate 72 are stably positioned and not movable relative to the board 13. To avoid unintentional release of the lock shaft 74, the bolt 75 is configured to be screwed within a threaded hole of the lock shaft 74 and be rotated to and received within a notch of the upper plate 71 so as to lock the lock shaft 74, which provides high level of safety. To adjust the adjusting assembly 70, it needs only to sufficiently unfasten the bolt 75 to unclamp the board 13 from the upper plate 71 and the lower plate 72, and the adjusting assembly 70 is easily and quickly adjustable by sliding along the board 13 without completely detaching the adjusting assembly 70 from the board 13 and without reinstallation of the adjusting assembly 70.

Additionally, the adjusting assembly 70 further includes a supporting post 76 and receptacle 77, the receptacle 77 is fixedly connected to the upper plate 71, and the supporting post 76 is assembled with the receptacle 77 by using at least one fastener such as screw. The seat mechanism 30 is connected to the supporting post 76 and adjustable in height. Specifically, the seat mechanism 30 includes a first tubular portion 31 at a lower portion thereof, and the first tubular portion 31 and the supporting post 76 are sleeved and relatively adjustable with each other, wherein the first tubular portion 31 and the supporting post 76 may be fixedly connected by at least one fastener such as screw or the like. The handle assembly 50 is adjustably connected to a front end of the seat mechanism 30. Specifically, the seat mechanism 30 further includes a second tubular portion 32 at a front portion thereof, the handle assembly 50 includes a handle 51 and a bar 52 perpendicular and connected to the handle 51, and the bar 52 is adjustably secured to the second tubular portion 32, wherein the bar 52 and the second tubular portion 32 may be fixedly connected by at least one fastener such as screw or the like.

The push handle assembly 60 is adjustably connected to a rear portion of the seat mechanism 30. Specifically, the rear portion of the seat mechanism 30 includes a third tubular portion 33, the push handle assembly 60 includes a handle 61, a bar 62, a lower tube 63 and a clamp 64, the lower tube 63 is secured to the third tubular portion 33, the bar 62 is perpendicular and connected to the handle 61 and is inserted within the lower tube 63, and the bar 62 and the lower tube 63 are fixedly secured by the clamp 64.

Given the above, with the seat mechanism 30 disposed on the adjusting assembly 70 which is adjustably disposed on the deck 10, the seat mechanism 30 is forwardly, backwardly, upwardly and downwardly adjustable relative to the deck 10 so that it provides more flexibility in adjusting seating space for children with different statures. Moreover, since the handle assembly 50 and the push handle assembly 60 are also adjustable relative to the seat mechanism 30, it provides excellent flexibility of use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A push scooter, including a deck, a wheel, a seat mechanism, a footrest and an adjusting assembly, wheels being disposed at a front end and a rear end of the deck, the footrest being disposed at the front end of the deck, the seat mechanism being adjustably disposed on the deck by the adjusting assembly.

2. The push scooter of claim 1, wherein the deck includes a front portion, a rear portion and a board connected between the front portion and the rear portion, the adjusting assembly is adjustably disposed on the board, and the seat mechanism is disposed on the adjusting assembly.

3. The push scooter of claim 2, wherein the adjusting assembly includes an upper plate and a lower plate, and the board is releasably clamped between the upper plate and the lower plate so that the adjusting assembly is forwardly and backwardly adjustable relative to the board.

4. The push scooter of claim 3, wherein the adjusting assembly further includes a hinge shaft and a lock shaft, sides of the upper plate and the lower plate at a side of the deck are hinged by the hinge shaft, and sides of the upper plate and the lower plate at another side of the deck are releasably locked by the lock shaft.

5. The push scooter of claim 4, wherein the adjusting assembly further includes a bolt locking the lock shaft with the upper plate and the lower plate.

6. The push scooter of claim 3, wherein the adjusting assembly further includes a supporting post and a receptacle, the receptacle is fixedly connected to the upper plate, the supporting post is assembled with the receptacle, the seat mechanism includes a first tubular portion at a lower portion thereof, and the first tubular portion and the supporting post are sleeved and relatively adjustable with each other.

7. The push scooter of claim 1, further including a handle assembly, wherein the handle assembly is adjustably connected to a front end of the seat mechanism.

8. The push scooter of claim 7, wherein the handle assembly includes a handle and a bar perpendicular and connected to the handle, the seat mechanism includes a second tubular portion at a front portion thereof, and the bar is adjustably secured to the second tubular portion.

9. The push scooter of claim 1, further including push handle assembly, wherein the push handle assembly is adjustably connected to a rear portion of the seat mechanism.

10. The push scooter of claim 9, wherein the rear portion of the seat mechanism includes a third tubular portion, the push handle assembly includes a handle, a bar, a lower tube and clamp, the lower tube is secured to the third tubular portion, the bar is perpendicular and connected to the handle and is inserted within the lower tube, and the clamp secures the bar and the lower tube.

11. The push scooter of claim 1, wherein the footrest is detachably assembled to a mounting hole of the deck, and the mounting hole is configured for mounting of a steering bar.

12. The push scooter of claim 7, wherein the handle assembly is adjustable in length along a direction oblique to the deck so that a height of the handle assembly relative to the seat mechanism and a relative position of the handle assembly in front of the seat mechanism are adjustable.
